(19) United States
(12) Patent Application Publication
(10) Pub. No.: US 2016/0164092 A1
(43) Pub. Date: Jun. 9, 2016

(54) IMPROVED LITHIUM METAL OXIDE RICH CATHODE MATERIALS AND METHOD TO MAKE THEM

(71) Applicant: DOW GLOBAL TECHNOLOGIES LLC, Midland, MI (US)

(72) Inventors: Alan L. Stottlemyer, Midland, MI (US); Koichi Numata, Midland, MI (US); Shijing Xia, Midland, MI (US); Hideaki Maeda, Tokyo (JP); Mark L. Dreibelbis, Midland, MI (US); Michael Gardner, Saginaw, MI (US)

(21) Appl. No.: 14/906,166

(22) PCT Filed: Aug. 5, 2014
(86) PCT No.: PCT/US14/49660

§ 371 Date: Jan. 19, 2016

Related U.S. Application Data
(60) Provisional application No. 61/867,256, filed on Aug. 19, 2013.

(51) Int. Cl. H01M 4/525; H01M 4/505

(52) U.S. Cl. CPC H01M 4/525; H01M 4/505; H01M 2004/028

(57) ABSTRACT

A method of doping elements (particularly those that do not have stable divalent oxidation states) into lithium rich metal oxides useful in lithium ion batteries is comprised of the following steps. A dopant metal is dissolved in a liquid, which includes being present as a colloid, to form a solution. The solution is added to a particulate lithium rich metal oxide precursor while agitating said precursor to form a mixture. The solution is added in an amount that is at most that amount which would make the mixture a paste. The liquid is removed to form a doped lithium rich metal oxide precursor. A source of lithium is added. The doped lithium rich metal oxide precursor is heated to form the lithium rich metal oxide.

### FIELD OF THE INVENTION

The invention relates to a method of making improved lithium rich metal oxide (LRMO) cathode materials for use in lithium ion batteries (LIBs). In particular the invention relates to a method incorporating dopant metals into the LRMOs that improve the cycle-ability of the LIBs made from the LRMOs.

### BACKGROUND OF THE INVENTION

Lithium ion batteries have, over the past couple of decades, been used in portable electronic equipment and more recently in hybrid or electric vehicles. Initially, lithium ion batteries first employed lithium cobalt oxide cathodes. Due to expense, toxicological issues, and limited capacity, other cathode materials have been or are being developed.

One promising class of materials that has been developed is often referred to as lithium rich metal oxide or lithium rich layered oxides (LRMO). These materials generally display a layered structure with monoclinic and rhombohedral domains (two phase) in which initial high specific discharge capacities (˜270 mAh/g) have been achieved when charged to voltages of about 4.6 volts vs Li/Li⁺. Unfortunately, these materials have suffered from a very short cycle life. The cycle life is generally taken as the number of cycles (charge-discharge) before reaching a definite capacity such as 80% of the initial specific capacity. Typically, the cycle life of these LIBs having LRMO cathodes has been less than 50 cycles. Each cycle for these materials is typically between the aforementioned 4.6 volts to 2 volts.

To solve the aforementioned cycle life problem, among others, dopant metals other than those typically used to make the LRMOs and coating have been described such as US Pat. Publ. Nos. 2013/149609; 2012/0263998; 2011/0081578; and 2007/0281212 and U.S. Pat. No. 7,435,402. Unfortunately, the improvements generally have been able to merely improve the cycle life on the order of a few tens or twenties, but at significant reduction of other properties such as initial specific discharge capacity.

Accordingly, it would be desirable to provide an improved LRMO and method to make the LRMO that improves LIBs made therefrom such as improving the cycle life of such batteries, without substantially reducing other desirable properties of these LIBs. In particular, it would be desirable to provide a method of doping or coating an LRMO such that an LIB, having such LRMO, has improved cycle life and desirable properties.

### SUMMARY OF THE INVENTION

We have discovered a method of adding dopant metals to LRMOs that surprisingly enhances the cycle life of LIBs made therefrom compared to prior methods of adding dopant metals. Illustratively, a cycle life of over 250 cycles has been possible. The invention is a method of incorporating dopant elements in a lithium rich metal oxide comprising:
(a) dissolving a dopant metal in a liquid to form a solution with the dopant metal dissolved in the solution;
(b) adding the solution to a particulate lithium rich metal oxide precursor while agitating said precursor to form a mixture, wherein the solution is added in an amount that is at most that amount which would make the mixture a paste;
(c) removing the liquid to form a doped lithium rich metal oxide precursor; and
(d) heating the doped lithium rich metal oxide precursor to form the lithium rich metal oxide.

It is not understood why the method of the present invention realizes the aforementioned cycle life without any substantial decrease in other properties, but, without limiting in any way, it may be due to the retention of particulate morphology of the lithium rich metal oxide precursor. That is, it has been observed that when dopant metals are co-precipitated with the core metals in the LRMOs, the morphology of the particulates are different and such differences are retained upon formation of the LRMO during the heating.

### BRIEF DESCRIPTION OF THE DRAWINGS

FIG. 1 is a graph of the capacity retention of a battery made with cathode material doped with aluminum using the method of this invention compared to a battery made with the same cathode not doped with Al.

FIG. 2 is a graph of the voltage retention of a battery made with cathode material doped with aluminum using the method of this invention compared to a battery made with the same cathode material that was not doped with Al.

FIG. 3 is a graph of the capacity retention of a battery made with cathode material without being doped with aluminum and the same cathode material doped with Al using a method not of this invention.

### DETAILED DESCRIPTION OF THE INVENTION

The applicants have discovered a method for doping lithium rich metal oxides (LRMOs). The lithium rich metal oxide (LRMO) may be any suitable one such as those known in the art. Exemplary LRMOs include those described in U.S. Pat. Nos. 5,993,998; 6,677,082; 6,680,143; 7,205,072; and 7,435,402, Japanese Unexamined Pat. No. 11307094A, EP Pat. Appl. No. 1193782; Chem. Mater. 23 (2011) 3614-3621; and J. Electrochem. Soc., 145:12, Dec. 1998 (4160-4168). Desirably, the lithium rich layered oxide is a lithium metal oxide wherein the metal is comprised of Mn or Co. Preferably the metal is comprised of Mn and at least one other metal that is a transition metal, rare earth metal, or combination thereof or is comprised of LiₓCoO₂ where x is greater than 1 and less than 2. More preferably, the metal is comprised of Mn, Ni and Co.

Illustratively, the lithium rich layered metal oxide is represented by a formula:

Li_{c}M_{y}O₂

Where 1<x<2, y is 1 and the metal may be any metal that has an oxidation state from 2 to 4. Preferably, M is a combination of metals, wherein one of the metals is Ni and it is present in a sufficient amount such that it is present in an oxidation state of at least +2. In a preferred embodiment, M is Ni, Mn and Co such that the composition in Ni_{1-a-b}MnₐCo_{b} can be described as 0.2≦a≦0.9 and 0≦b≦0.8.

It is understood that the LRMOs may also contain small amounts of anionic dopants that improve one or more properties, with an example being fluorine. Likewise, the lithium rich layered metal oxides may also be coated with various coatings to improve one or more properties after they have been doped. Exemplary LRMOs include those described by U.S. Pat. Nos. 7,205,072 and 8,187,752.

The LRMOs typically display a specific capacity after being initially charged to 4.6 volts by the traditional formation method described above of at least about 250 mAh/g when discharged at a C rate of 0.05 between 2 and 4.6 volts. A C rate of 1 means charging or discharging in 1 hour between the aforementioned voltages. A rate of C/10 is a rate where the charging or discharging equals 10 hours. A C rate of 10 C is equal to 6 minutes.

The method comprises dissolving a dopant metal in a liquid. The liquid may be any liquid that dissolves a compound containing the desired dopant metal. Typically, the liquid is a polar solvent that is capable of solvating metal salts. Exemplary solvents include alcohols, ethers, esters, organic and inorganic acids, ketones, aromatics, water and mixtures thereof. It is desirable for the polar solvent to be water, tetrahydrofuran, isopropanol, ethanol, tartaric acid, acetic acid, acetone, methanol, dimethylsulfoxide, N-Methyl-2-pyrrolidone (NMP), acetonitrile, or a combination thereof. Desirably, the solvent is water, which may be neutral, acidic or basic depending on the particular dopant metal compounds desired to be dissolved.

The dopant metal may be any useful for improving the LRMO and illustratively may be Al, Mg, Fe, Cu, Zn, Sb, Y, Cr, Ag, Ca, Na, K, In, Ga, Ge, W, V, Mo, Nb, Si, Ti, Zr, Ru, Ta, Sn, or combination thereof. Preferably, the dopant metal is Al, Ga, Nb, Mg, Fe, Ti or combination thereof. More preferably, the dopant metal is Al or Mg.

Even though the dopant metal may be dissolved directly, for example, in a sufficiently acidic aqueous solution, it is preferable to dissolve a compound of the dopant metal such as an ionic compound (e.g., salt). Exemplary compounds of the aforementioned dopant metals include a nitrate, sulfate, hydroxide, carboxylate, carbonate, chloride, fluoride, iodide, alkoxide (e.g., isopropoxide or ethoxide), acetylacetonate, acetate, oxalate, or mixture thereof. Preferably, the dopant compound is a nitrate, hydroxide, carboxylate, oxalate, carbonate or mixture thereof. Most preferably, the dopant compound is a nitrate. It is understood that the dopant metal or compounds thereof, may be mixed metal compounds or one or more singular metal compounds that are dissolved in the liquid when more than one dopant metal is desired. Preferably, the dopant metal compound is aluminum nitrate, magnesium nitrate, tin acetylacetonate, copper nitrate, gallium nitrate, and ruthenium acetate.

In another embodiment, the dopant metal may be present as a solid in colloid dispersion so long as the particulate size of the colloid suspended in the liquid is of small enough size to penetrate into the pores of the lithium rich metal oxide precursor (LRMO precursor) described below when the dopant metal is dissolved in the solvent. Typically, the colloid particles when using such a method have an average particle size of at most about 100 nm to about 1 nm Desirably, the average particle size of the colloid is at most 75, 50, or 25 nm

The dissolving may be aided by the application of heating and stirring, but is generally not necessary so long as the dopant metal or dopant metal compound is dissolved in the liquid in the desired amount at ambient conditions. The amount of the dopant metal dissolved in the solvent is generally an amount that results in an amount of about 0.05% to 15% by mole in the final LRMO. The amount needed in the liquid is readily determinable from the amount desired and the amount of solution necessary to make a LRMO precursor into a paste as described below. The amount of dopant metal in the LRMO is typically at least 0.1%, 0.2%, 0.5% or 1% to 10%, 8%, 7%, 5% or 4%.

The solution is added to a particulate lithium rich metal oxide precursor (LRMO precursor) by any suitable method while agitating the particulate LRMO precursor. The LRMO may be any suitable LRMO precursor for making LRMOs such as those known in the art. The particulate precursor may be, for example, individual metal compounds that decompose and sinter in a solid state reaction such as the aforementioned compounds described for dopant metal compounds. Preferably, the LRMO precursor is a mixed metal compound, which may be made by any suitable process such as co-precipitation, sol gel or other like method such as described by U.S. Pat. No. 6,677,082, U.S. Pat. No. 7,585,435, U.S. Pat. No. 7,645,542, U.S. Pat. No. 8,277,683, WO2010042434, WO2013047569. It is desirable that the LRMO precursor is made by co-precipitation.

To reiterate, the particulate LRMO precursor is preferably a mixed metal LRMO precursor that has a certain average primary, average secondary particle size and morphology. The method has been surprisingly found to be able to preserve the precursor particle size and morphology in the final LRMO. “Same size” generally means that the secondary particle size is within 25% of the corresponding precursor LRMO average secondary particle size. As to morphology, this is a more subjective measure, but in essence is when side by side scanning electron micrographs of the precursor and final LRMO have the same shape to the naked eye to one of ordinary skill.

Generally, the LRMO precursor has an average primary particle size from 5 to 500 nanometers. Typically, the primary particle size is from 50, 75, 100 nanometers to 200 nanometers. Generally, the specific surface area is 0.1 m²/g to 500 m²/g. Typically, the specific surface area is 0.5, 1, 2 or 5 m²/g to 250, 100, 50, or 20 m²/g.

The precursor LRMO particulates generally, are sufficiently dried such that they are easily agitated by known agitation methods without clumping. A typical apparatus used to agitate may be any known mixing equipment such as muller mixers, screw mixers, paddle mixers and the like. The amount of solution necessary to reach a paste may be easily determined by a method akin to determining the oil absorption number in the carbon black industry as per ASTM D-2414-09. In this technique, a liquid, such as the solution herein, is added drop wise to a given amount of powder being stirred by a torque rheometer until a sharp rise in torque occurs. The sharp rise in torque, in essence, is where enough liquid has been added to make the powder become a paste. Likewise, one can slowly add the solution to a powder and hand agitate until the powder first becomes paste like.

It is preferred that the solution be added at a slow enough rate and under sufficient agitation so that the solution is uniformly distributed throughout the LRMO precursor forming a mixture. “Uniformly distributed” means that ten random 1 g samples of the LRMO formed from the precursor has a dopant metal concentration in which the standard deviation is no more than about 20% of the mean concentration, but preferably is no more than about 10% of the mean concentration. The particular addition rate and agitation vigor is a function of each particular LRMO precursor, solution, equipment, mixture mass and the like. The rate of addition should be no more than the ability of the powder to uptake the solution into the bulk of the precursor material, so as to avoid any puddling that persists after significant agitation of the powder. If possible, it is desirable to avoid all puddling of the solution. The particular uptake may vary from one precursor powder to another, but a typical maximum rate of solution uptake is about 3 to 5 cc/min per 100 grams of precursor LRMO particulate.

Once the solution has been added to the LRMO precursor to form the mixture, the liquid of the solution is removed, depositing the dopant metal on the surface of the LRMO precursor and in its pores forming a doped precursor LRMO. The removing of the liquid may be accomplished by any suitable method, such as evaporative drying without assistance or with assistance such as heating, freeze drying, vacuum drying or the like. The heating may be done by any suitable method such as microwave, induction, convection, resistance, radiation heating or combination thereof. The drying and subsequent heating to form the lithium rich metal oxide may be done in one process step or in separate process steps.

The doped lithium rich metal oxide precursor is heated to a temperature sufficient to form the desired lithium rich metal oxide that has been doped. Prior to this heating if a lithium source is not present in the LRMO precursor or is not present in an amount sufficient to form the desired LRMO upon heating, the lithium source may be added at any convenient time. Typically, the lithium source may be added as needed after the doped LRMO precursor has been dried. The lithium source may be any suitable lithium source such as those known in the art and include, for example, a lithium salt such as lithium carbonate, lithium hydroxide, lithium nitrate, or combinations thereof.

In an embodiment, the lithium source is a solid compound that has been added after the doped LRMO has been dried but not yet heated to form the doped LRMO, wherein it is desirable for the solid lithium source to have a specific surface area that is greater than the doped LRMO. Desirably, in this embodiment, the lithium source's specific surface area is at least 1.2, 1.5, 1.8, 2 or even 5 times to at most about 250, 100, 50 or even 20 times greater than the specific surface area of the doped LRMO precursor. Typically, the specific surface area of the doped LRMO precursor is about the same as described above for the undoped LRMO precursor.

In another embodiment, the lithium source is a solid and is mixed with the LRMO precursor prior to doping wherein the specific surface area of the lithium source is less than the specific surface area of the LRMO precursor in a sufficient amount so as to not deleteriously affect the uptake of the dopant metal into the pores and on the LRMO precursor. Desirably, in this embodiment, the lithium source's specific surface area is at least 2, 3, 4 or even 5 times to at most about 40, 30, 25 or even 20 times less than the specific surface area of the doped LRMO precursor.

The temperature of heating the LRMO precursor to form the LRMO is dependent, for example, on the particular LRMO being formed and the precursor LRMO and dopant metal used. Typically, the temperature is 400° C. to 1200° C. More typically, the temperature is from 500° C., 600° C., 700° C., to 1000° C. or 900° C. The heating may also contain one or more holds at differing temperature until the final temperature desired is reached. The atmosphere may be oxidative, inert, or vacuum or combination thereof during the heating. The time at the heating temperature may be any useful, but, is desirably as short a time possible that still achieves the desired LRMO. The time, for example, may be seconds to several days. Typically, the time is several minutes to 3 to 4 hours, which is also applicable to any intermediate temperature hold.

The doped LRMO of this invention has been surprisingly found to give improved cycle life without substantial decreases in other useful properties of the LRMOs. For example, an LIB having an LRMO made by this invention's method may have a cycle life of 50% or greater compared to an LRMO not having been doped. The cycle life may be more than 200, 300, 400 or even 500 cycles.

The method of this invention has also surprisingly enabled the incorporation of elements into LRMOs that provide useful properties whereas when they are attempted to be incorporated by co-precipitating to form the LRMO precursors, no beneficial effect is observed and in many instances the desired properties are deleteriously affected. For example, the present method may be particularly useful in doping with elements that lack a stable divalent oxidation state (+2), whereas co-precipitating with the LRMO precursor generally results in undesirable results. Of course the method may be used to dope elements with a stable divalent oxidation state. In particular, the method is preferred when doping element without a divalent oxidation state when the precursor LRMOs are formed using co-precipitation of carbonate compounds containing at least one Ni, Co or Mn.

LIBs comprised of a cathode having the invention's LRMO may have any suitable design. Such a battery typically comprises, in addition to the cathode, an anode, a porous separator disposed between the anode and cathode, and an electrolyte solution in contact with the anode and cathode. The electrolyte solution comprises a solvent and a lithium salt.

Suitable anode materials include, for example, carbonaceous materials such as natural or artificial graphite, carbonized pitch, carbon fibers, graphitized mesophase microspheres, furnace black, acetylene black, and various other graphitized materials. Suitable carbonaceous anodes and methods for making them are described, for example, in U.S. Pat. No. 7,169,511. Other suitable anode materials include lithium metal, lithium alloys, other lithium compounds such as lithium titanate and metal oxides such as TiO₂, SnO₂ and SiO₂, as well as materials such as Si, Sn, or Sb. The anode may be made using one or more suitable anode materials.

The separator is generally a non-conductive material. It should not be reactive with or soluble in the electrolyte solution or any of the components of the electrolyte solution under operating conditions but must allow lithium ionic transport between the anode and cathode. Polymeric separators are generally suitable. Examples of suitable polymers for forming the separator include polyethylene, polypropylene, polybutene-1, poly-3-methylpentene, ethylene-propylene copolymers, polytetrafluoroethylene, polystyrene, polymethylmethacrylate, polydimethylsiloxane, polyethersulfones and the like.

The battery electrolyte solution has a lithium salt concentration of at least 0.1 moles/liter (0.1 M), preferably at least 0.5 moles/liter (0.5 M), more preferably at least 0.75 moles/liter (0.75 M), preferably up to 3 moles/liter (3.0 M), and more preferably up to 1.5 moles/liter (1.5 M). The lithium salt may be any that is suitable for battery use, including lithium/salts such as LiAsF₆, LiPF₆, LiPF₄(C₂O₄), LiPF₂(C₂O₄)₂, LiBF₄, LiB(C₂O₄)₂, LiBF₂C₂O₄), LiClO₄, LiBrO₄, LiIO₄, LiB(C₆H₅)₄, LiCH₃SO₃, LiN(SO₂C₂F₅)₂, and LiCF₃SO₃. The solvent in the battery electrolyte solution may be or include, for example, a cyclic alkylene carbonate like ethylene carbonate; a dialkyl carbonate such as diethyl carbonate, dimethyl carbonate or methylethyl carbonate, various alkyl ethers; various cyclic esters; various mononitriles; dinitriles such as glutaronitrile; symmetric or asymmetric sulfones, as well as derivatives thereof; various sulfolanes, various organic esters and ether esters having up to 12 carbon atoms, and the like.

### EXAMPLES

Each of the Examples and Comparative Examples in Table 1 used the same lithium rich metal oxide precursor (LRMO precursor) which would form an LRMO upon calcining having the chemical formula Li_{1.2}Ni_{0.17}Mn_{0.56}Co_{0.07}O₂. The LRMO precursor was prepared from the corresponding co-precipitated transition metal precursor by known techniques using the corresponding metal carbonate precursors for Examples A-P. For Examples A-P, LRMO precursor was doped using incipient wetness impregnation as follows. The solvents used were water, ethanol, isopropanol, and tetrahydrofuran as shown in Table 1. The metal salt is dissolved in a solvent and added drop-wise to the LRMO precursor until the incipient wetness point is reached as described above. After reaching the incipient wetness point, the powder may be dried, for example at a low temperature where the LRMO is not formed (e.g., 130° C. for 30 minutes) and the process repeated to add further dopant metal. Repeating the addition in this way is useful, for example, when the amount of dopant metal that can be dissolved in the volume of liquid at the incipient wetness point is insufficient to realize the amount of dopant desired in the LRMO precursor.

After the final dropwise addition of dopant solution, the wetted powder was dried overnight at 130° C. Li₂CO₃ (99.2%, SQM North America, Atlanta, Ga.) was added in an amount to achieve the aforementioned Li amount in the LRMO and the mixture was ball milled 30 minutes using 3 mm yttria stabilized zirconia media at a 4:1 ratio of media to powder. This mixture was calcined at 850° C. for 10 hours using 5 hour ramp rates for heating and cooling.

Coin cells were manufactured in the same way using the LRMO produced in each Example and Comparative Example as follows.

The LRMO of each Example and Comparative Example was mixed with SUPER P™ carbon black (Timcal Americas Inc. Westlake, Ohio), VGCF™ vapor grown carbon fiber (Showa Denko K.K. Japan) and polyvinylidene fluoride (PVdF) (Arkema Inc., King of Prussia, Pa.) binder in a weight ratio of LRMO:SuperP:VGCF:PVdF of 90:2.5:2.5:5. A slurry was prepared by suspending the cathode material, conducting material, and binder in solvent N-Methyl-2-pyrrolidone (NMP) followed by homogenization in a vacuum speed mixer (Thinky USA, Laguna Hills, Calif.). The NMP to solids ratio was approximately 1.6:1 before defoaming under mild vacuum. The slurry was coated on to battery grade aluminum foil using a doctor blade to an approximate thickness of 30 micrometers and dried for thirty minutes at 130° C. in a dry convection oven. The aluminum foil was 15 micrometers thick. 2025 type coin cells were made in a dry environment (dew point less than or equal to −40° C.).

The electrodes were pressed on a roller press to approximately 17 micrometers resulting in an active material density of about 2.7 to about 3.0 g/cc. The cells had a measured loading level of about 5 mg/cm². The electrolyte was ethylene carbonate/diethyl carbonate (EC:DEC, 1:9 by volume) with 1.2 M LiPF₆. The anode was 200 micrometers thick high purity lithium foil available from Chemetall Foote Corporation, New Providence, N.J. The separator was a commercially available coated separator.

The cells were cycled on a MACCOR Series 4000 battery testing station (MACCOR, Tulsa, Okla.). Each of Examples and its Comparative Example were activated in the same manner (i.e., Example 1A and Comparative Example A). Prior to cycling, the cells were first cycled to determine the initial capacity of the battery at a C rate of 0.05 and then the capacity was also determined, in order thereafter at C rates of 0.1, 0.33, 1, 3, 5 except Example 1A and Comparative Example A which were only cycled to 0.05 C and 0.1 C and then cycled at 1 C thereafter.

### Comparative Examples A-P

Coin half cells were made with lithium rich metal oxide (LRMO) as described above. In each Comparative Example, the precursor LRMO was processed directly (i.e., without any doping) into the LRMO with the corresponding Examples as shown in Table 1 at the same time and assembled into coin cells as well as tested at the same time as the corresponding Examples. That is Comparative Example A corresponds to those Examples labeled 1A, 2A etc., which were doped with Al. The intended metal dopant concentration in the LRMO and the ICP measured concentration were measured and are shown in Table 1. ICP means inductively coupled plasma atomic emission spectroscopy.

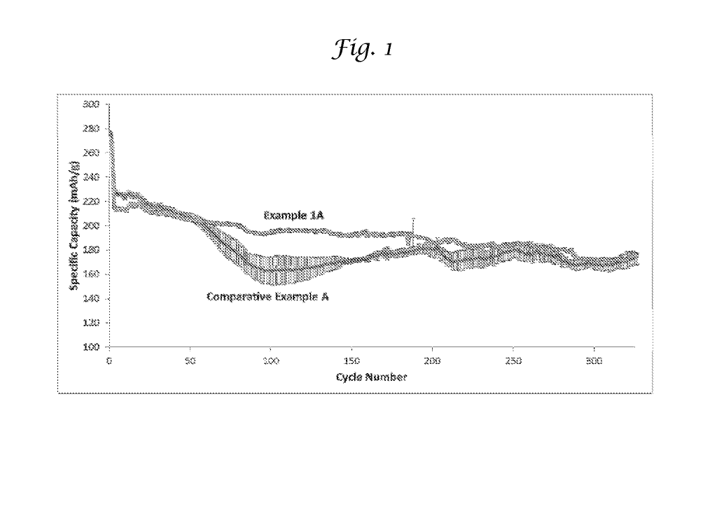

As shown in FIG. 1, the cycle stability of Example 1A is significantly improved compared to Comparative Example A. Adding the dopant improves energy retention by 7% and capacity retention by 6%. Furthermore, the cell-by-cell variability is decreased by almost 300% for Example 1A compared to Comparative Example A.

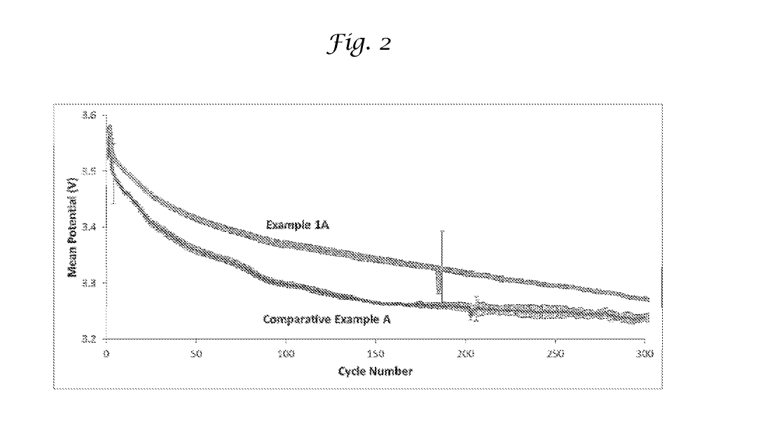

As shown in FIG. 2, the mean operating voltage of Example 1A is greater than that of Comparative Example A. This demonstrates that adding Al to lithium rich metal oxide using the incipient wetness process raises the operating voltage of the cell. Furthermore, Al doping using the incipient wetness process lowers the 50 cycle voltage drop by 16%.

As shown in Table 1, a wide variety of dopants can be added to lithium rich metal oxide using the method of this invention. Such a variety of dopants allows the electrochemical characteristics of the cathode material to be tuned to accommodate operating conditions. General observations from the Table of individual elements are as follows. Mg and Ga improved the capacity of the battery. Al, Ag, Cu, Ga, Sn, Ti, and Zn improved the cycle stability of the battery. Al, Ag, Cu, Nb, Sn, Ti, Zn improved voltage retention of the battery.

### Comparative Examples R and T

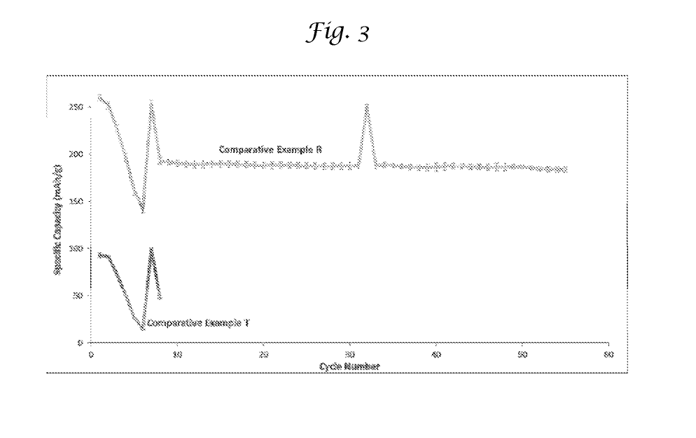

0.6 M aqueous solution of transition metal sulfates in the ratio necessary to make the same LRMO described previously (with or without an aluminum sulfate as dopant) were dissolved in deionized water and pumped into 3L of 0.1 M potassium hydroxide at 0.6 L/hr feeding rate so as to form a precursor LRMO. The LRMO without co-precipitating with Al is Comparative Example R and with co-precipitating with Al is Comparative Example T. The reaction was continued until a pH of 8.3 was reached. The resulting slurry was washed and filtered. After drying at 110° C. overnight, the hydroxide precursor was mixed with required amount of lithium hydroxide and calcined in air at 850° C. for 10 hours using 5 hours to heat up to and down from 850° C. The electrochemical performance of Comparative Example R and Comparative Example T is shown in FIG. 3.

As was shown previously in FIG. 1, adding Al to lithium rich metal oxide using incipient wetness impregnation improves the cycle stability (Example 1A) compared to the control (Comparative Example A). However, as shown in FIG. 3, when the same amount of Al is added to the material using co-precipitation the electrochemical performance suffers significantly (Comparative Example T) compared to the material without Al (Comparative Example R) and in particular to Example 1A. Likewise, when preparing an LRMO precursor by co-precipitation using the same precursors and methods of Comparative Example A, except that Al is also co-precipitated therewith, the electrochemical performance was essentially the same as that for Comparative Example T.

TABLE 1

| | | | | measured | | | normal- | | | | |
|---|---|---|---|---|---|---|---|---|---|---|---|
| | | | meas- | doping | | | ized | | | | |
| | | doping | ured | level | | | capacity | | | | |
| | | level [mol | Li/M | by ICP | normal- | normal- | reten- | normalized | normalized | | |
| | | % of | ratio | [mol % of | ized | ized | tion | energy | voltage | | |
| | | transition | by | transition | C/10 | 1 C | at 50 | retention | drop (50 | | |
| label | dopant | metals] | ICP | metals] | capacity | capacity | cycles | at 50 cycles | cycles) | dopant salt | solvent |
| Comparative | | 0 | NA | NA | 1.00 | 1.00 | 1.00 | 1.00 | 1.00 | | |
| Example A | | | | | | | | | | | |
| Example 1A | Al | 3 | NA | NA | 0.97 | 0.94 | 1.06 | 1.07 | 0.84 | aluminium | water |
| | | | | | | | | | | nitrate | |
| Comparative | | 0 | 1.48 | 0.00 | 1.00 | 1.00 | 1.00 | 1.00 | 1.00 | | |
| Example B | | | | | | | | | | | |
| Example 1B | Ag | 1 | 1.45 | 1.08 | 0.95 | 0.94 | 1.01 | 0.98 | 0.83 | silver nitrate | water |
| Example 2B | Ag | 3 | 1.38 | 3.15 | 0.94 | 0.92 | 0.99 | 0.98 | 0.89 | silver nitrate | water |
| Example 3B | Ag | 5 | 1.37 | 5.05 | 0.87 | 0.86 | 0.81 | 0.96 | 1.08 | silver nitrate | water |
| Comparative | | 0 | 1.48 | 0.00 | 1.00 | 1.00 | 1.00 | 1.00 | 1.00 | | |
| Example C | | | | | | | | | | | |
| Example 1C | Cu | 1 | 1.45 | 0.81 | 0.97 | 0.94 | 1.05 | 1.02 | 1.06 | copper (II) | water |
| | | | | | | | | | | nitrate | |
| Example 2C | Cu | 3 | 1.44 | 2.34 | 0.88 | 0.82 | 1.05 | 1.05 | 0.84 | copper (II) | water |
| | | | | | | | | | | nitrate | |
| Example 3C | Cu | 5 | 1.38 | 3.84 | 0.85 | 0.78 | 1.01 | 1.02 | 0.62 | copper (II) | water |
| | | | | | | | | | | nitrate | |
| Comparative | | 0 | 1.48 | 0.00 | 1.00 | 1.00 | 1.00 | 1.00 | 1.00 | | |
| Example D | | | | | | | | | | | |
| Example 1D | Ga | 0.5 | 1.45 | 0.52 | 1.06 | 1.09 | 1.00 | 1.00 | 1.42 | gallium nitrate | water |
| Example 2D | Ga | 1 | 1.44 | 1.02 | 1.02 | 1.01 | 1.02 | 1.01 | 1.16 | gallium nitrate | water |
| Example 3D | Ga | 3 | 1.44 | 3.06 | 0.98 | 0.95 | 1.02 | 1.02 | 1.22 | gallium nitrate | water |
| Comparative | | 0 | 1.48 | 0 | 1.00 | 1.00 | 1.00 | 1.00 | 1.00 | | |
| Example E | | | | | | | | | | | |
| Example 1E | Mg | 1 | 1.52 | 0.87 | 0.95 | 0.90 | 1.03 | 1.03 | 1.09 | magnesium | water |
| | | | | | | | | | | nitrate | |
| Example 2E | Mg | 3 | 1.49 | 2.86 | 0.84 | 0.78 | 1.04 | 1.05 | 0.93 | magnesium | water |
| | | | | | | | | | | nitrate | |
| Example 3E | Mg | 5 | 1.49 | 4.67 | 0.73 | 0.67 | 1.08 | 1.08 | 0.87 | magnesium | Water |
| | | | | | | | | | | nitrate | |
| Comparative | | 0 | 1.48 | 0.00 | 1.00 | 1.00 | 1.00 | 1.00 | 1.00 | | |
| Example F | | | | | | | | | | | |
| Example 1F | Nb | 0.5 | 1.58 | 0.32 | 0.96 | 0.88 | 1.01 | 1.00 | 0.65 | ammonium | water |
| | | | | | | | | | | niobate oxalate | |
| Example 2F | Nb | 1 | 1.53 | 0.68 | 0.86 | 0.73 | 0.99 | 1.01 | 0.89 | ammonium | water |
| | | | | | | | | | | niobate oxalate | |
| Example 3F | Nb | 3 | 1.51 | 1.87 | 0.93 | 0.81 | 1.02 | 1.01 | 0.73 | ammonium | water |
| | | | | | | | | | | niobate oxalate | |
| Comparative | | 0 | 1.48 | 0.00 | 1.00 | 1.00 | 1.00 | 1.00 | 1.00 | | |
| Example G | | | | | | | | | | | |
| Example 1G | Sn | 0.5 | 1.54 | 0.50 | 1.00 | 1.00 | 1.06 | 1.01 | 1.08 | tin | tetrahydrofuran |
| | | | | | | | | | | acetylacetonate | |
| Example 2G | Sn | 1 | 1.52 | 0.97 | 0.84 | 0.75 | 1.07 | 1.06 | 0.63 | tin | tetrahydrofuran |
| | | | | | | | | | | acetylacetonate | |
| Example 3G | Sn | 3 | 1.53 | 2.86 | 0.72 | 0.59 | 1.09 | 1.08 | 0.38 | tin | tetrahydrofuran |
| | | | | | | | | | | acetylacetonate | |
| Example 4G | Sn | 5 | 1.47 | 4.74 | 0.75 | 0.64 | 1.08 | 1.05 | 0.57 | tin | tetrahydrofuran |
| | | | | | | | | | | acetylacetonate | |
| Comparative | | 0 | 1.48 | 0.00 | 1.00 | 1.00 | 1.00 | 1.00 | 1.00 | | |
| Example H | | | | | | | | | | | |
| Example 1H | Ti | 1 | 1.52 | 0.72 | 0.98 | 0.94 | 1.02 | 1.02 | 0.87 | titanium | isopropanal |
| | | | | | | | | | | diisopropoxide | |
| | | | | | | | | | | bis(acetylacetonate) | |
| Example 2H | Ti | 3 | 1.55 | 2.12 | 0.98 | 0.96 | 1.01 | 1.01 | 0.91 | titanium | isopropanal |
| | | | | | | | | | | diisopropoxide | |
| | | | | | | | | | | bis(acetylacetonate) | |
| Example 3H | Ti | 5 | 1.50 | 3.38 | 0.99 | 0.96 | 1.00 | 1.01 | 0.89 | titanium | isopropanal |
| | | | | | | | | | | diisopropoxide | |
| | | | | | | | | | | bis(acetylacetonate) | |
| Comparative | | 0 | 1.48 | 0.00 | 1.00 | 1.00 | 1.00 | 1.00 | 1.00 | | |
| Example J | | | | | | | | | | | |
| Example 1J | Zn | 1 | 1.47 | 1.08 | 0.95 | 0.90 | 1.03 | 1.00 | 0.89 | zinc nitrate | water |
| Example 2J | Zn | 3 | 1.23 | 3.15 | 0.87 | 0.81 | 1.04 | 1.00 | 0.78 | zinc nitrate | Water |
| Example 3J | Zn | 5 | 1.39 | 5.04 | 0.87 | 0.81 | 1.03 | 1.00 | 0.94 | zinc nitrate | water |
| Comparative | | 0 | 1.48 | 0.00 | 1.00 | 1.00 | 1.00 | 1.00 | 1.00 | | |
| Example K | | | | | | | | | | | |
| Example 1K | Sb | 1 | 1.45 | 0.95 | 0.99 | 0.96 | 1.02 | 1.02 | 0.99 | antimony | Tartaric acid in |
| | | | | | | | | | | acetate | water |
| Example 2K | Sb | 3 | 1.40 | 2.71 | 0.92 | 0.88 | 1.03 | 1.02 | 0.93 | antimony | Tartaric acid in |
| | | | | | | | | | | acetate | water |
| Example 3K | Sb | 5 | 1.37 | 4.34 | 0.73 | 0.66 | 1.00 | 0.98 | 1.03 | antimony | Tartaric acid in |
| | | | | | | | | | | acetate | water |
| Comparative | | 0 | 1.48 | 0.00 | 1.00 | 1.00 | 1.00 | 1.00 | 1.00 | | |
| Example L | | | | | | | | | | | |
| Example 1L | Cr | 1 | 1.44 | 1.02 | 1.01 | 1.00 | 0.87 | 0.87 | 0.98 | chromium (III) | water |
| | | | | | | | | | | nitrate | |
| Example 2L | Cr | 3 | 1.40 | 2.88 | 0.98 | 0.93 | 0.86 | 0.86 | 0.95 | chromium (III) | water |
| | | | | | | | | | | nitrate | |
| Example 3L | Cr | 5 | 1.38 | 4.73 | 0.96 | 0.90 | 0.89 | 0.89 | 0.86 | chromium (III) | water |
| | | | | | | | | | | nitrate | |
| Comparative | | 0 | 1.48 | 0.00 | 1.00 | 1.00 | 1.00 | 1.00 | 1.00 | | |
| Example M | | | | | | | | | | | |
| Example 1M | Y | 1 | 1.45 | 0.97 | 0.94 | 0.86 | 1.09 | 1.09 | 0.96 | yttrium (III) | water |
| | | | | | | | | | | nitrate | |
| Example 2M | Y | 3 | 1.38 | 2.96 | 0.91 | 0.84 | 1.08 | 1.09 | 0.95 | yttrium (III) | water |
| | | | | | | | | | | nitrate | |
| Example 3M | Y | 5 | 1.34 | 5.03 | 0.88 | 0.81 | 1.08 | 1.09 | 0.89 | yttrium (III) | water |
| | | | | | | | | | | nitrate | |
| Comparative | | 0 | 1.48 | 0.00 | 1.00 | 1.00 | 1.00 | 1.00 | 1.00 | | |
| Example N | | | | | | | | | | | |
| Example 1N | Ge | 1 | 1.46 | 1.09 | 0.95 | 0.91 | 1.03 | 1.03 | 0.88 | germanium (IV) | isopropanol |
| | | | | | | | | | | isopropoxide | |
| Example 2N | Ge | 3 | 1.42 | 3.05 | 0.90 | 0.85 | 1.01 | 1.01 | 0.83 | germanium (IV) | isopropanol |
| | | | | | | | | | | isopropoxide | |
| Example 3N | Ge | 5 | 1.64 | 4.51 | 0.73 | 0.69 | 0.96 | 0.95 | 0.94 | germanium (IV) | isopropanol |
| | | | | | | | | | | isopropoxide | |
| Comparative | | 0 | 1.48 | 0.00 | 1.00 | 1.00 | 1.00 | 1.00 | 1.00 | | |
| Example P | | | | | | | | | | | |
| Example 1P | Ta | 1 | 1.42 | 1.04 | 0.96 | 0.95 | 0.97 | 0.97 | 0.86 | tantalum (V) | ethanol |
| | | | | | | | | | | ethoxide | |
| Example 2P | Ta | 3 | 1.42 | 2.83 | 0.84 | 0.80 | 0.95 | 0.94 | 0.80 | tantalum (V) | ethanol |
| | | | | | | | | | | ethoxide | |

*NA = data is not available

1. A method of incorporating dopant elements in a lithium rich metal oxide comprising:
(a) dissolving a dopant metal in a liquid to form a solution with the dopant metal dissolved in the solution;
(b) adding the solution to a particulate lithium rich metal oxide precursor while agitating said precursor to form a mixture, wherein the solution is added in an amount that is at most that amount which would make the mixture a paste;
(c) removing the liquid to form a doped lithium rich metal oxide precursor;
(d) adding a lithium source, and
(e) heating the doped lithium rich metal oxide precursor to form the lithium rich metal oxide.

2. The method of claim 1, wherein the lithium rich metal oxide precursor is a mixed metal precursor that is a nitrate, sulfate, hydroxide, oxide, carboxylate, carbonate or mixture thereof.

3. The method of claim 2, wherein the mixed metal precursor is the carbonate.

4. The method of claim 1, wherein the liquid is a polar solvent.

5. The method of claim 4, wherein the liquid is water.

6. The method of claim 1, wherein said agitating is sufficiently vigorous to uniformly distribute the solution throughout the lithium rich metal oxide precursor.

7. The method of claim 1, wherein the lithium rich metal oxide precursor has a specific surface area of 0.1 to 500 m2/g.

8. The method of claim 7, wherein the lithium rich metal oxide precursor has an average primary particle size of 5 to 500 nanometers and an average secondary particle size from 0.5 to 35 micrometers.

9. The method of claim 1, wherein the dopant metal is Al, Mg, Fe, Cu, Zn, Sb, Y, Cr, Ag, Ca, Na, K, In, Ga, Ge, W, V, Mo, Nb, Si, Ti, Zr, Ru, Ta, Sn or combination thereof.

10. The method of claim 9, wherein the dopant metal is Al, Mg, Ga, Sn, Fe, Nb or combination thereof.

11. The method of claim 1, wherein the heating is to a temperature of 400 to 1100° C.

12. The method of claim 1, wherein the adding of the solution to the particulate lithium rich precursor is at a rate sufficiently slow to uniformly distribute the solution throughout to lithium rich metal oxide precursor.

13. The method of claim 1, wherein the lithium rich metal oxide has the same particle size and morphology as the lithium rich metal oxide precursor.

14. A lithium rich metal oxide made by the method of claim 1.

15. A lithium ion battery comprised of a cathode having the lithium rich metal oxide of claim 14.

16. The lithium ion battery of claim 15, wherein the cycle life of the battery is at least 50% longer than a lithium ion battery having a cathode comprised of a lithium rich metal oxide formed and doped by co-precipitation of the dopant metal with the metals of the lithium rich metal oxide.

17. The process of claim 1, wherein a source of lithium is added to the doped lithium rich precursor prior to heating.

18. The process of claim 17, wherein the source of lithium has a specific surface area that is at least the same or greater than the surface area of the particulate lithium rich metal oxide precursor.

19. The process of claim 1, wherein a source of lithium is added in step (b) and said lithium source has a surface area that is less than the surface area of the particulate lithium rich metal oxide precursor.

20. The process of claim 4, wherein the polar solvent is tetrahydrofuran, isopropanol, ethanol, tartaric acid, acetic acid, acetone, methanol, dimethylsulfoxide, N-Methyl-2-pyrrolidone, acetonitrile, or a combination thereof.
